(19) United States
(12) Patent Application Publication
(10) Pub. No.: US 2018/0082067 A1
(43) Pub. Date: Mar. 22, 2018

(54) Information Sharing Server, Information Sharing System And Non-Transitory Recording Medium

(71) Applicant: Konica Minolta, Inc., Tokyo (JP)

(72) Inventor: Toshinobu Yamaguchi, Osaka (JP)

(73) Assignee: Konica Minolta, Inc., Tokyo (JP)

(21) Appl. No.: 15/710,178

(22) Filed: Sep. 20, 2017

(30) Foreign Application Priority Data
Sep. 20, 2016 (JP) 2016-182831

(51) Int. Cl. G06F 21/60; H04L 29/06; G06F 21/62; G06F 17/30

(52) U.S. Cl. CPC G06F 21/602; H04L 63/0428; G06F 17/30014; G06F 21/6218; G06F 17/30091; G06F 21/6209

(57) ABSTRACT

An information sharing server includes a hardware processor that: registers multiple users who share document data as members of a group; obtains the document data encrypted by one user of the multiple users in said group and a password to decrypt the encrypted document data; stores the encrypted document data and said password in association with each other on a predetermined storage; reads the encrypted document data and said password in said storage and decrypts the encrypted document data using said password when a request for browsing of the encrypted document data is received from one of the multiple users in said group; and provides a sender of said request for browsing with the decrypted document data.

This application claims priority to Japanese patent application No. 2016-182831, filed on Sep. 20, 2016, the entire disclosure of which is incorporated herein by reference.

### BACKGROUND

Technological Field

The present invention relates to an information sharing server, an information sharing system and a non-transitory recording medium. The present invention more specifically relates to a technique to share document data among multiple users.

### Description of the Related Art

A conventional information sharing service that requires installation of an information sharing server which serves as a web server on a cloud connected to an internet to enable multiple users to access the information sharing server from different locations to log into the server, thereby enabling the multiple users to have a meeting with sharing information is provided. This type of the information sharing service enables each user to upload created document data to the information sharing server so that the multiple users are allowed to share the document data.

The information sharing server has a function not to disclose the uploaded document data except for the multiple users registered in advance. Password protected encrypted highly confidential document data may be uploaded to the information sharing server. This known technique is introduced for example in Japanese Patent Application Laid-Open No. JP 2014-174721 A. According to the known technique, the information sharing server stores therein the password protected encrypted document data as sharing information.

Each document data may have different password which is added to the corresponding document data stored in the information sharing server. In this case, each user is not allowed to view the document data unless he or she inputs the password added to the corresponding document data. The user who uploads the document data is required to inform the other users of the password added to the document data, which is bothersome.

The user who uploads the document data may provide the other users with screen information for viewing the document data. In this case, the other users are allowed to view the document data even though they do not know the password added to the document data. The other users are then allowed to view only when the user who uploads the document data is viewing, resulting in less user-friendliness.

The user who uploads the document data may add any password. The information sharing server is not capable of having information about the password so that it is not allowed to enable the other users to use a preview function to preview the password protected encrypted document data.

If the user who uploads the document data may upload the document data to the information sharing server without password protecting the document data, and the aforementioned problem is solved. In such a case, however, the document data may be downloaded by the other users, and it is not allowed to put a restriction about viewing the document data, resulting in an increased risk of information leakage.

### SUMMARY

The present invention is intended to solve the above problems. Thus, the present invention is intended to provide an information sharing server, an information sharing system and a non-transitory recording medium capable of allowing another user to browse the document data even if he or she does not know the password when the document data encrypted with the password is uploaded, resulting in the enhanced operability in the use of the encrypted document data.

First, the present invention is directed to an information sharing server.

To achieve at least one of the abovementioned objects, the information sharing server reflecting one aspect of the present invention comprises a hardware processor that: registers multiple users who share document data as members of a group; obtains the document data encrypted by one user of the multiple users in said group and a password to decrypt the encrypted document data; stores the encrypted document data and said password in association with each other on a predetermined storage; reads the encrypted document data and said password in said storage and decrypts the encrypted document data using said password when a request for browsing of the encrypted document data is received from one of the multiple users in said group; and provides a sender of said request for browsing with the decrypted document data.

Second, the present invention is directed to an information sharing system.

To achieve at least one of the abovementioned objects, the information sharing system reflecting one aspect of the present invention comprises: an information sharing server according to claim 1; and an information processing device that uploads document data to said information sharing server. The information processing device includes a second hardware processor that: encrypts the document data with a password specified by a user; and uploads the encrypted document data and said password to said information sharing server.

According to another aspect of the present invention, the information sharing system comprises: an information sharing server according to claim 1; and an image processing device that uploads document data to said information sharing server. The image processing device includes: a document reader that generates the document data by reading a document; and a second hardware processor. The second hardware processor encrypts the document data generated by said document reader with a password specified by a user and uploads the encrypted document data and said password to said information sharing server.

Third, the present invention is directed to a non-transitory recording medium storing a computer readable program to be executed by a computer.

To achieve at least one of the abovementioned objects, according to an aspect of the present invention, the non-transitory recording medium reflecting one aspect of the present invention stores the computer readable program, execution of which by computer causing the computer to perform: registering multiple users who share document data as members of a group; obtaining the document data encrypted by one of the multiple users in said group and a password to decrypt the encrypted document data; storing the encrypted document data and said password in association with each other; reading the encrypted document data and said password and decrypting the encrypted document data using said password when a request for browsing of the encrypted document data is received from one of the multiple users in said group; and providing a sender of said request for browsing with the decrypted document data.

### BRIEF DESCRIPTION OF THE DRAWING

The advantages and features provided by one or more embodiments of the invention will become more fully understood from the detailed description given herein below and the appended drawings which are given by way of illustration only, and thus are not intended as a definition of the limits of the present invention.

FIG. 1 shows an exemplary conceptual configuration of an information sharing system;

FIG. 2 is a block diagram showing an example of a hardware structure and a functional structure of an information processing device;

FIG. 3 is a block diagram showing an example of a hardware structure and a functional structure of an image processing device;

FIG. 4 is a block diagram showing an example of a hardware structure and a functional structure of an information sharing server;

FIG. 5 shows an example of sharing information;

FIG. 6 shows a concept of an encryption by an upload data obtaining unit;

FIG. 7 shows an example of management information;

FIG. 8 is a block diagram showing an example of a detailed functional structure of a decrypting part;

FIG. 9 is a block diagram showing an example of a detailed functional structure of a browsing information generator;

FIG. 10 shows an example of a browsing screen displayed on a display area of the information processing device;

FIG. 11 is a flow diagram showing an exemplary process sequence when document data is uploaded to the information sharing server and is browsed;

FIG. 12 is a flow diagram showing an exemplary process sequence when the document data is downloaded;

FIG. 13 is a flow diagram showing an exemplary process sequence when the document data is printed;

FIG. 14 is a flow diagram explaining an exemplary procedure of a main process performed at the information sharing server;

FIG. 15 is a flow diagram explaining in detail an exemplary procedure of a document data registration;

FIG. 16 is a flow diagram explaining in detail an exemplary procedure of a browsing information providing process;

FIG. 17 is a flow diagram explaining in detail an exemplary procedure of a document data providing process;

FIG. 18 is a flow diagram explaining in detail an exemplary procedure of a print controlling process; and

FIG. 19 is a flow diagram showing an exemplary process sequence when the document data is uploaded to the information sharing server.

### DETAILED DESCRIPTION OF EMBODIMENTS

Hereinafter, one or more embodiments of the present invention will be described with reference to the drawings. However, the scope of the invention is not limited to the disclosed embodiments.

### First Preferred Embodiment

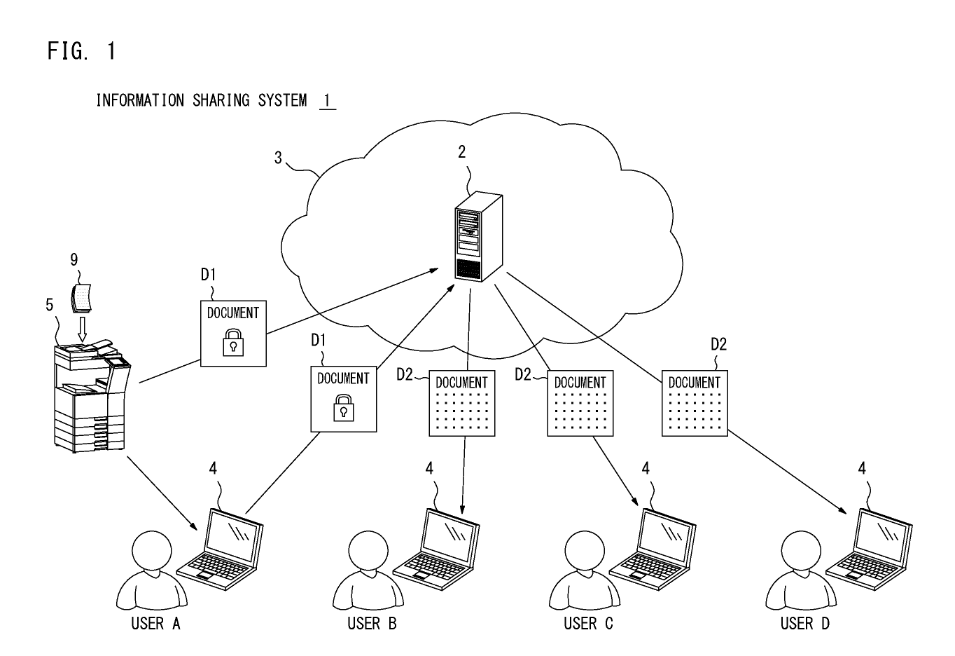

FIG. 1 shows an exemplary conceptual configuration of an information sharing system 1 of the present invention. The information processing system 1 comprises an information sharing server 2 installed on a cloud 3 connected to an internet, multiple information processing devices 4 and an image processing device 5 constructed by a device such as a MFP (Multifunction Peripherals) including a scan function and a print function. Those devices are connected to each other via a network such as the internet so that they are allowed to send and receive data to and from each other. Each of the multiple information processing devices 4 is constructed by a device such as a general personal computer (PC), for instance. Each information processing device 4 is used by the respective users A, B, C and D. Those users A, B, C and D are located at a different place, for example. The image processing device 5 is located at the same place as the user A, for instance, and is allowed to be used by the user A.

The information sharing server 2 includes a variety of functions including a web server function, information sharing function and a video conference function. The information sharing server 2 provides with an information sharing service that enables the multiple users A, B, C and D registered in advance to share the same information. When document data D1 is uploaded from the information processing device 4 which is used by the user A, for example, the information sharing server 2 stores and manages the document data D1. In response to receiving a request to browse the document data D1 from one of the other users B, C and D, the information sharing server 2 discloses the document data D1 uploaded by the user A to another user B, C or D.

The document data D1 may be the data of a highly confidential document. In this case, the user A operates the information processing device 4 for uploading the document data D1, and adds a password to the document data D1, thereby encrypting the document data D1. The user A uploads the document data D1 encrypted with the added password to the information sharing server 2. The information processing device 4 sends the encrypted document data D1 to the information sharing server 2 together with the password to decrypt the document data D1 (the password added by the user A).

The user A is also allowed to upload the document data D1 generated by reading a document 9 using the scan function in the image processing device 5 to the information sharing server 2. There are two ways, the first way and the second way to upload the document data D1. The first way is to upload the document data D1 generated at the image processing device 5 to the information sharing server 2 from the information processing device 4 of the user A after forwarding the document data D1 to the information processing device 4 of the user A. The second way is to upload the document data D1 generated at the image processing device 5 directly to the information sharing server 2 from the image processing device 5. For the first way, the user A may put the password and encrypt the document data D1 at either the image processing device 5 or the information processing device 4. On the other hand, for the second way, the image processing device 5 receives an operation to put the password by the user A, encrypts the document data D1 generated by reading the document 9, and sends the password put to the document data D1 by the user A to the information sharing server 2 together with the encrypted document data D1.

After receiving the encrypted document data D1 and the password from the information processing device 4 of the user A or the image processing device 5, the information sharing server 2 stores the document data D1 and the password in association with each other. The information sharing server 2 manages the document data D1 uploaded by the user A as the document data to be shared by the multiple users A, B, C and D registered in advance.

When the other users B, C and D access the document data D1 uploaded by the user A, each user B, C and D uses his or her information processing device 4 to access the information sharing server 2 and logs into the information sharing server 2. Each user B, C and D sends the browsing request to browse the document data D1 uploaded by the user A to the information sharing server 2.

After receiving the browsing request from another user B, C or D, the information sharing server 2 reads the encrypted document data D1 uploaded by the user A and the password. The information sharing server 2 decrypts the encrypted document data D1 with the password put by the user A, and generates document data D2 available for the other users B, C and D. The information sharing server 2 then creates a browsing screen based on the decrypted document data D2, and sends it to the information processing device 4 of each user B, C and D. As a result, the other users B, C and D are allowed to browse the document data D1 even without knowing the password protecting the document data D1 put by the user A. The information sharing system 1 is explained in detail next.

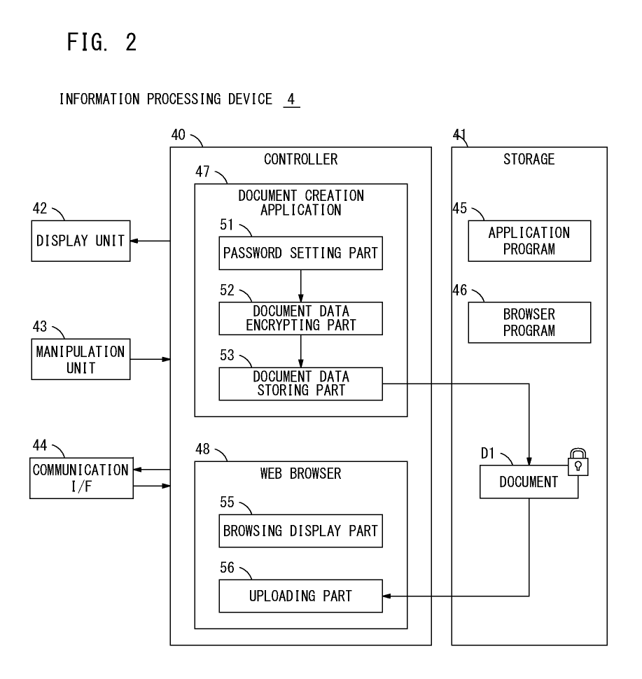

First, the information processing device 4 is explained. FIG. 2 is a block diagram showing an example of a hardware structure and a functional structure of the information processing device 4. As its hardware structure, the information processing device 4 includes a controller 40, a storage 41, a display unit 42, a manipulation unit 43 and a communication interface 44. The controller 40 includes a CPU and a memory, and the storage 11 stores a variety of information. The display unit 42 is formed from a device such as a color liquid crystal display, for instance, and the manipulation unit 43 is formed with parts such as a keyboard, a mouse and/or a touch panel. The communication interface 44 is to communicate with another device such as the information sharing server 2.

The storage 41 is formed from a non-volatility device such as a hard disk drive (HDD) or a solid state drive (SSD). An application program 45 executed by the CPU of the controller 40 and/or a browser program 46 is stored in the storage 41. The application program 45 is to run a document creation application 47 to create the document data D1 at the information processing device 4. The browser program 46 is to obtain the browsing screen such as a web page at the information processing device 4 and run a web browser 48 to display the browsing screen on the display unit 42. The document data D1 to be uploaded to the information sharing server 2 may also be stored in the storage 41.

The document creation application 47 creates and edits the document based on user operations to the manipulation unit 43, and generates the document data D1. The document creation application 47 includes a password setting part 51, a document data encrypting part 52 and a document data storing part 53.

The password setting part 51 becomes operative for encrypting the document data D1 created based on the user operation. The password setting part 51 displays a password setting screen on the display unit 42, and receives the password input to the manipulation unit 43 by the user. The password setting part 51 sets the password input by the user as that for encryption of the document data D1, and outputs the password to the document data encrypting part 52.

The document data encrypting part 52 encrypts the document data D1 with the password set by the password setting part 51. The document data D1 is successfully converted into encrypted data which is not disclosed to users unless input of the correct password. The document data encrypting part 52 outputs the encrypted document data D1 to the document data storing part 53.

The document data storing part 53 stores the encrypted document data D1 in the storage 41. If the encryption of the document data D1 is not specified by the user, the document data storing part 53 may also store the document data D1 which is not encrypted in the storage 41.

The web browser 48 accesses an address of a URL specified by the user via the communication interface 44, and communicates with the server that has the accessed address. The web browser 48 obtains the browsing screen from the server and displays the screen on the display unit 42 and/or sends to the server operation information based on the user operation to the browsing screen. The web browser 48 includes a browsing display part 55 and an uploading part 56. The browsing display part 55 obtains the browsing screen from the server and displays the screen on the display unit 42. Moreover, the browsing display part 55 sends the operation information to the server. The function of the browsing display part 55 is one of standard functions included in the web browser 48. The web browser 48 executes a program a script program contained in the browsing screen obtained from the server, for example, so that the uploading part 56 is realized. The uploading part 56 uploads the document data D1 specified by the user to the server.

It is assumed that the web browser 48, for example, accesses the information sharing server 2 and executes the script program contained in the browsing screen obtained from the information sharing server 2 so that the uploading part 56 becomes operative. In this case, the uploading part 56 uploads the document data D1 specified by the user to the information sharing server 2. When uploading the password protected encrypted document data D1 to the information sharing server 2, the uploading part 56 uploads the password to decrypt the document data D1 together with the encrypted document data D1. For uploading the encrypted document data D1 to the information sharing server 2, the uploading part 56 displays the password input screen on the display unit 42 and receives the input of the password by the user. After the operation to input the password by the user is complete, the uploading part 56 uploads the password input by the user to the information sharing server 2 together with the encrypted document data D1.

Hence, when sending the encrypted document data D1 to the information sharing server 2, the information processing device 4 is capable of uploading not only the encrypted document data D1 but also the password to decrypt the encrypted document data D1 to the information sharing server 2 at the same time.

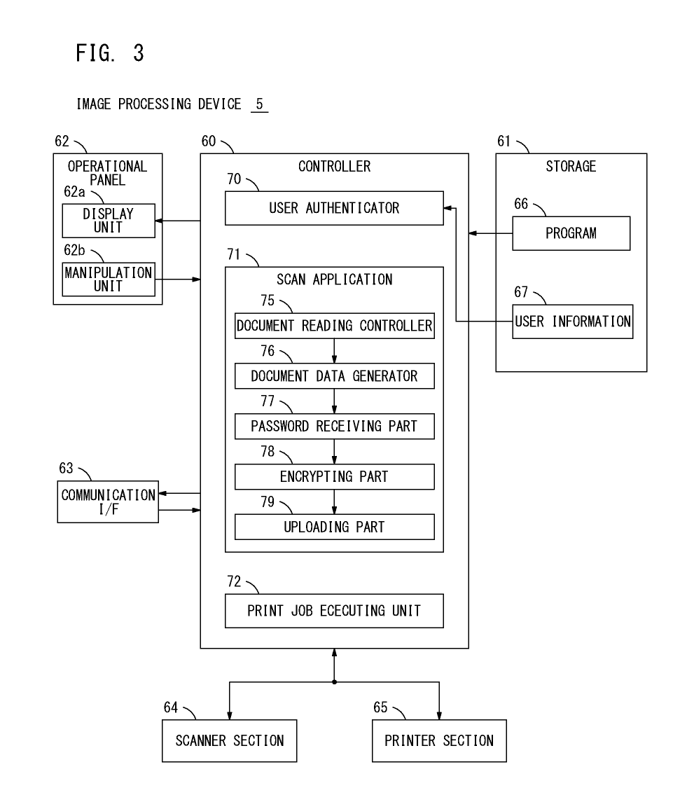

The image processing device 5 is explained next. FIG. 3 is a block diagram showing an example of a hardware structure and a functional structure of the image processing device 5. As its hardware structure, the image processing device 5 includes a controller 60, a storage 61, an operational panel 62, a communication interface 63, a scanner section 64 and a printer section 65. The controller 60 includes a CPU and a memory, and the storage 61 stores a variety of information. The operational panel 62 is to be a user interface for use of the image processing device 5 by the user. The communication interface 63 is to communicate with another device such as the information sharing server 2. The scanner section 64 optically reads an image of the document, and the printer section 65 produces a printed output. The operational panel 62 includes a display unit 62a on which a variety of information is displayed and a manipulation unit 62b that receives the operation by the user. The storage 61 is formed from a non-volatility device such as a hard disk drive (HDD). A program 66 executed by the CPU of the controller 60 and/or user information 67 with which information relating to the user using the image processing device 5 is registered is stored in the storage 61, for example.

The CPU of the controller 60 automatically reads and executes the program 66 in the storage 61 at the startup of the image processing device 5. The controller 60 then serves as a user authenticator 70, a scan application 71 and a print job executing unit 72.

The user authenticator 70 authenticates the user who uses the image processing device 5. The user authenticator 70 determines whether or not the information input by the user using the operational panel 62 is registered with the user information 67, thereby authenticating the user. If the information input by the user is registered with the user information, the authentication results in success. The user authenticator 70 puts the image processing device 5 into a logged-in state available for the user. If the information input by the user is not registered with the user information, the authentication results in failure. In this case, the user is not allowed to use the image processing device 5.

The scan application 71 becomes operative when the logged-in user who is successfully authenticated selects the use of the scan function. The scan application 71 goes through the user information 67, thereby determining if the user logged into the image processing device 5 is the user who is allowed to use the information sharing server 2. If the logged-in user is allowed to use the information sharing server 2, a function that is capable of uploading the document data D1 generated with the scan function to the information sharing server 2 becomes operative. The scan application 71 is then serves as a document reading controller 75, a document data generator 76, a password receiving part 77, an encrypting part 78 and an uploading part 79.

The document reading controller 75 outputs an operation order to the scanner section 64, thereby controlling the reading operation of the document 9 placed by the user and obtaining the data generated by reading the document 9. The document data generator 76 converts the data obtained by the document reading controller 75 into a predetermined data form such as PDF (Portable Document Format), and generates the document data D1. The password receiving part 77 becomes operative when the encryption of the document data D1 is specified by the user. The password receiving part 77 receives the input of the password by the user. The encrypting part 78 puts the password specified by the user to the document data D1 generated by the document data generator 76 and encrypts the document data D1, thereby converting it into the encrypted data. The uploading part 79 uploads the encrypted document data D1 and the password specified by the user to the information sharing server 2. When uploading the document data D1, the uploading part 79 extracts the information relating to the logged-in user from the user information 67, and sends the information relating to the logged-in user to the information sharing server 2. The information sharing server 2 is then allowed to identify the user who uploads the document data D1.

The print job executing unit 72 becomes operative when receiving the print job or the document data D1 via the communication interface 63. The print job executing unit 72 drives the printer section 65 based on the print job or the document data D1, and enables the image processing device 5 to produce the printed output.

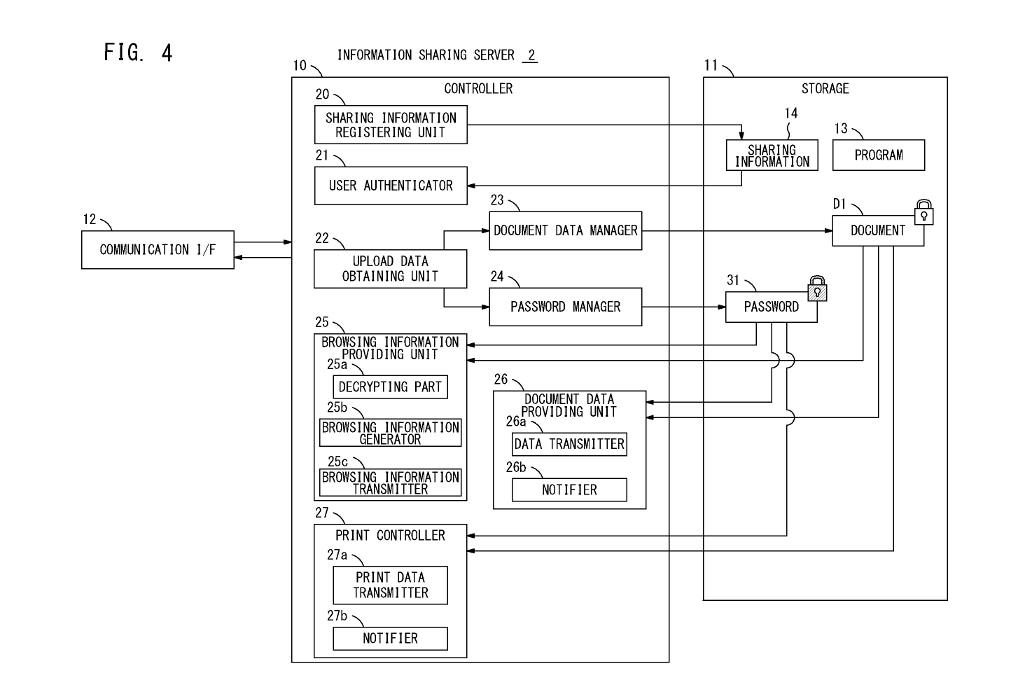

The information sharing server 2 is explained next. FIG. 4 is a block diagram showing an example of a hardware structure and a functional structure of the information sharing server 2. As illustrated in FIG. 4, the information sharing server 2 includes a controller 10, a storage 11, and a communication interface 12. The hardware structure of the information sharing server 2 is the same as a general computer. The controller 10 includes a CPU and a memory, and the storage 11 stores a variety of information. The communication interface 12 is to communicate with the information processing device 4 and/or the image processing device 5. The storage 11 is formed from a non-volatility device such as a hard disk drive (HDD). A program 13 executed by the CPU of the controller 10 is stored in advance in the storage 11. Information relating to the multiple users who share the document data D1 is registered with sharing information 14. Information including the sharing information 14, the document data D1 shared by the multiple users and a password 31 put to the document data D1 is stored in the storage 11.

The CPU of the controller 10 reads and executes the program 13 in the storage 11 at the startup of the information sharing server 2. The controller 10 then serves as a sharing information registering unit 20, a user authenticator 21, an upload data obtaining unit 22, a document data manager 23, a password manager 24, a browsing information providing unit 25, a document data providing unit 26 and a print controller 27.

The sharing information registering unit 20 registers the information such as that relating to the multiple users who share the information with the sharing information 14 based on a setting operation by an administrator, for instance. The sharing information registering unit 20, for example, becomes operative when the administrator logs into the information sharing server 2. The sharing information registering unit 20 registers the information relating to a group in which the information is shared or the user who is allowed to share the information with another user in the group is registered with the sharing information 14 based on the setting operation by the administrator.

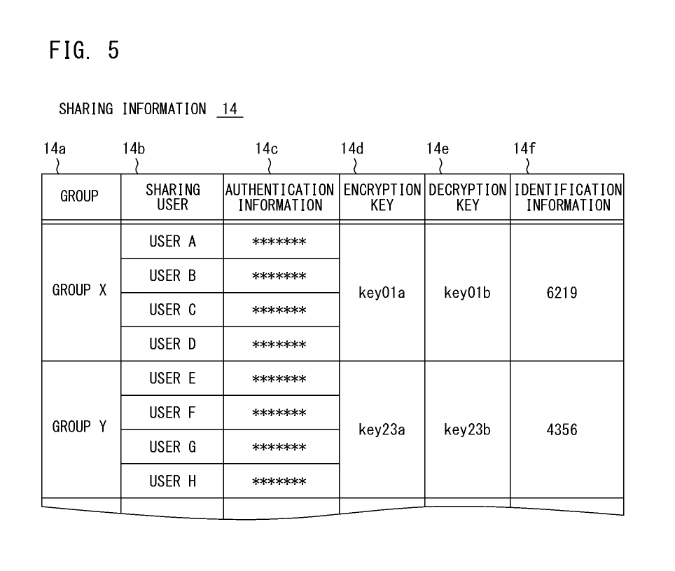

FIG. 5 shows an example of the sharing information 14. As shown in FIG. 5, group information 14a, sharing user information 14b, authentication information 14c, an encryption key 14d, a decryption key 14e and identification information 14f is included in the sharing information 14. In the example of FIG. 5, two groups, a group X and a group Y are registered as the groups in which the information is shared. Four users, users A, B, C and D are registered as the users who share the information in the group X. Four users A, B, C and D in the group X are allowed to share the document data D1 uploaded to the group X. Four other users, users E, F, G and H are registered as the users who share the information in the group Y. Four users E, F, G and H in the group Y are allowed to share the document data D1 uploaded to the group Y. The groups are managed as described above so that the information sharing server 2 is allowed to identify the logged-in user's group when the user logs in. As a resut, only the document data D1 uploaded to the logged-in user's group is disclosed to the logged-in user, also a disclosure of the document data D1 uploaded to another group besides the logged-in user's group can be restricted.

Information to identify the individual user is registered as the authentication information 14c. The authentication information 14c is formed from a random character string, for instance, that is assigned to each user individually. Information formed from a combination of the user ID and the password may be the authentication information 14c. When a login request from the user is received, the authentication information 14c is used to authenticate the user.

The encryption key 14d is key information set to each group by the administrator, for example. The encryption key 14d is used to encrypt the password for decryption of the encrypted document data D1. The decryption key 14e is decryption key information that is a pair with the encryption key 14d. The decryption key 14e is set to each group by the administrator, for example, and used to decrypt the encrypted password.

The identification information 14f is the unique information set to each group by the administrator, for example. The identification information 14f is formed from information such as a four to eight-digit personal identification number (a PIN code).

The identification information 14f should not always be managed separately from the description key 14e as illustrated in FIG. 5. It may be set in advance with the description key 14e to use the description key 14e. As an optional function to generate the description key 14e, there is a function to set the identification information 14f with the description key 14e, for example. By using such optional function, the identification information 14f may be set with the description key 14e. In this case, it is not necessary to store the identification information 14f separately from the description key 14e in the sharing information 14. Then, the description key 14e, for instance, is encrypted with the identification information 14f.

Once a new group is registered with the sharing information 14, the sharing information registering unit 20 notifies each of the multiple users registered as the members of the group of the authentication information 14c and the identification information 14f individually. It is assumed that a new user is registered as a member of the existing group which has already been registered with the sharing information 14. In this case, the sharing information registering unit 20 notifies the new user of the authentication information 14c and the identification information 14f. When notifying each user of the authentication information 14c and the identification information 14f, the sharing information registering unit 20 attaches information such as address information to access the information sharing server 2 and sends the aforementioned information with the attachment. The user who received the notification uses his or her information processing device 4 to access the information sharing server 2. Also, the user is allowed to know the authentication information 14c to log into the information sharing server 2 and the unique identification information 14f assigned to his or her group. The notification by the sharing information registering unit 20 is sent by email, for example.

The user authenticator 21 becomes operative when the communication interface 12 receives the login request from the information processing device 4. The user authenticator 21 performs a user authentication. The user authenticator 21 determines if the information included in the login request matches with the authentication information 14c registered for each user with the sharing information 14, thereby authenticating the user. The information included in the login request may match with the authentication information 14c. In this case, the authentication results in success. The user authenticator 21 identifies the user corresponding to the authentication information 14c and his or her group. The user authenticator 21 puts the information sharing server 2 into the logged-in state in which the user is allowed to use the uploaded document data available for his or her group. The information included in the login request may not match with the authentication information 14c. In this case, the authentication results in failure. The user authenticator 21 does not put the information sharing server 2 into the logged-in state.

The upload data obtaining unit 22 becomes operative when the communication interface 12 receives the uploaded data. The upload data obtaining unit 22 obtains the uploaded data from the information processing device 4 or the image processing device 5. After obtaining the uploaded data, the upload data obtaining unit 22 identifies the uploaded user from the information contained in the uploaded data, and refers to the sharing information 14. The upload data obtaining unit 22 then identifies the uploaded user's the group.

When the encrypted document data D1 and the password are contained in the uploaded data, the upload data obtaining unit 22 separates the document data D1 and the password from the uploaded data. The upload data obtaining unit 22 outputs the encrypted document data D1 to the document data manager 23, and the password to the password manager 24. The upload data obtaining unit 22 is also configured to encrypt the password contained in the uploaded data before outputting it to the password manager 24.

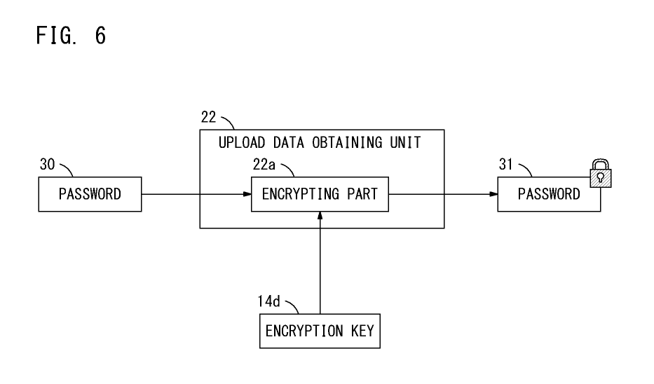

FIG. 6 shows a concept of the encryption by the upload data obtaining unit 22. As shown in FIG. 6, the upload data obtaining unit 22 includes an encrypting part 22a. The encrypting part 22a becomes operative when the password is contained in the uploaded data received from the information processing device 4 or the image processing device 5. The encrypting part 22a reads the ecryption key 14d registered with the user's group who has received the uploaded data in the sharing information 14, and encrypts a password 30 received from the information processing device 4 or the image processing device 5 with the ecryption key 14d. To be more specific, the encrypting part 22a encrypts the password 30 with the ecryption key 14d registered with the group in which the document data D1 is shared, thereby generating an encrypting password 31. The upload data obtaining unit 22 outputs the encrypting password 31 to the password manager 24.

The document data manager 23 stores the document data D1 received from the upload data obtaining unit 22 in the storage 11 and manages. The password manager 24 stores the encrypting password 31 received from the upload data obtaining unit 22 in the storage 11 and manages. The document data manager 23 and the password manager 24 generates management information 35 in which the encrypted document data D1 and the encrypting password 31 are associated with each other. The document data manager 23 and the password manager 24 share the management information 35 so that they are allowed to manage the encrypted document data D1 and the encrypting password 31 associated with each other on a one-to-one basis.

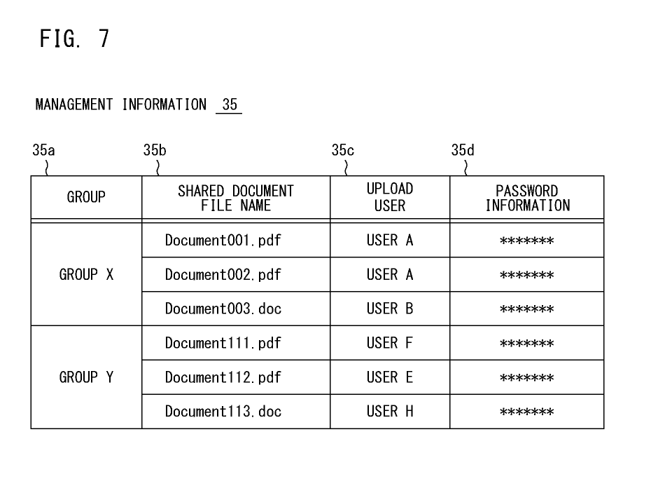

FIG. 7 shows an example of the management information 35. The management information 35 includes group information 35a, shared document file name information 35b, upload user information 35c and password information 35d. The group information 35a shows the group in which the document data D1 is shared. The shared document file name information 35b shows a file name of the shared document data D1. The upload user information 35c shows the user who uploaded the document data D1. The password information 35d is to identify the encrypting password 31 generated by encryption of the password 30 that is used to decrypt the document data D1. Hence, by referring to the management information 35 shown in FIG. 7, it is identifiable that what group is allowed to share the document data D1 stored in the storage 11 and the encrypting password 31 corresponding to the respective document data D1. Also, by referring to the management information 35, the upload user of the document data D1 may be identified. The document data manager 23 and the password manager 24 share and manage the management information 35 so that the encrypted document data D1 may be stored in the storage 11 in a way that enables the identification of the group in which the data is shared, the upload user and the encrypting password 31.

The browsing information providing unit 25 becomes operative when the information sharing server 2 enters the logged-in state in which the logged-in user is logging in. The browsing information providing unit 25 provides with the access information of the document data D1 that may be shared by the logged-in user. It is assumed, for example, the logged-in user logs in. In this case, the browsing information providing unit 25 refers to the sharing information 14, thereby identifying the logged-in user's group. The browsing information providing unit 25 notifies the document data manager 23 of the identified group. The browsing information providing unit 25 obtains list information of the document data D1 shared in the logged-in user's group from the document data manager 23. The browsing information providing unit 25 provides the information processing device 4 used by the logged-in user with the list information based on the obtained list information. As a result, the logged-in user is allowed to find the list of the document data D1 available for him or her. The logged-in user then is allowed to select one of the document data D1 on the list and send the browsing request to the information sharing server 2.

After receiving the browsing request that designating the document data D1 from the logged-in user's information processing device 4, the browsing information providing unit 25 puts a decrypting part 25a, a browsing information generator 25b and a browsing information transmitter 25c into operation one after the other.

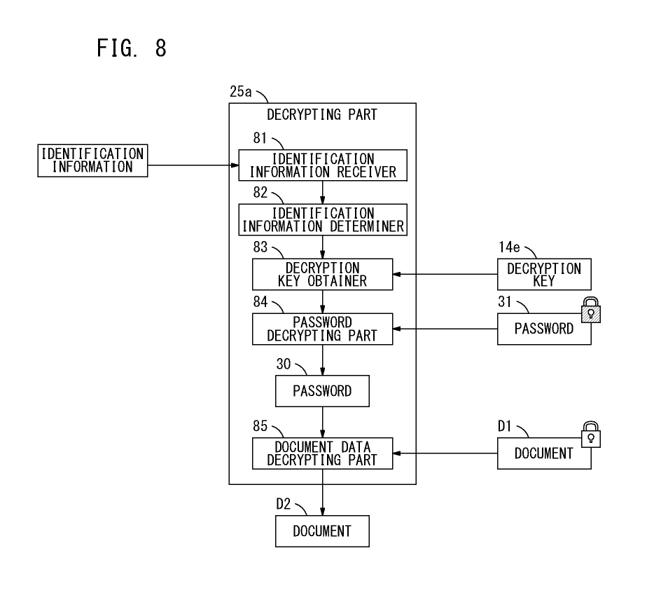

The decrypting part 25a decrypts the encrypted document data D1 which is designated by the logged-in user. FIG. 8 is a block diagram showing an example of a detailed functional structure of the decrypting part 25a. As shown in FIG. 8, the decrypting part 25a includes an identification information receiver 81, an identification information determiner 82, a decryption key obtainer 83, a password decrypting part 84 and a document data decrypting part 85.

The identification information receiver 81 receives an input of the identification information by the logged-in user. The identification information receiver 81 sends an identification information input screen that requests the input of the identification information to the logged-in user's information processing device 4. The identification information receiver 81 then receives the identification information input by the logged-in user through the identification information input screen, and outputs the received identification information to the identification information determiner 82.

The identification information determiner 82 determines if the identification information input by the logged-in user matches with the identification information 14f registered with the sharing information 14. After obtaining the identification information input by the logged-in user from the identification information receiver 81, the identification information determiner 82 refers to the sharing information 14. The identification information determiner 82 then determines if the identification information matches with the identification information 14f registered as the information identifying the logged-in user's group. The logged-in user is logging into the information sharing server 2. Even in this state, the logged-in user is requested to input the identification information and the input identification information is determined if it matches with the identification information 14f registered in advance with the sharing information 14. As a result, it avoids in advance the access to the document data D1 by an impersonator, realizing the security with the improved security.

The decryption key obtainer 83 becomes operative when the identification information determiner 82 determines that the identification information input by the logged-in user matches with the identification information 14f registered with the sharing information 14. The decryption key obtainer 83 refers to the sharing information 14, and obtains the decryption key 14e registered as the information relating to the logged-in user's group. After obtaining the decryption key 14e, the decryption key obtainer 83 outputs the obtained decryption key 14e to the password decrypting part 84.

As described above, when the identification information 14f corresponding to the decryption key 14e is registered, the aforementioned identification information determiner 82 is not specifically required. To be more specific, in such a case, the decryption key obtainer 83 may be configured to obtain the decryption key 14e by using the identification information 14f input by the logged-in user. The encrypted decryption key 14e may be decrypted with the identification information 14f input by the logged-in user, for example. The decryption key obtainer 83 outputs the decryption key 14e obtained by using the identification information 14f to the password decrypting part 84. Even by using the identification information 14f input by the logged-in user, the decryption key 14e registered as the information relating to the logged-in user's group may not be obtained normally. For example, this may be a case where the identification information 14f input by the logged-in user does not allow the decryption of the decryption key 14f normally. In such a case, the later process is not performed. Hence, it avoids in advance the unauthorized access to the document data D1 from someone who is being as the logged-in user.

After obtaining the decryption key 14e, the password decrypting part 84 makes an inquiry about the encrypting password 31 to decrypt the encrypted document data D1 which is designated by the logged-in user to the password manager 24. The password decrypting part 84 then reads and obtains the encrypting password 31 in the storage 11 based on a response from the password manager 24. The password decrypting part 84 decrypts the encrypting password 31 using the decryption key 14e ontained from the decryption key obtainer 83. The encrypting password 31 is decrypted to the password 30 which is used to decrypt the encrypted document data D1 which is designated by the logged-in user.

The document data decrypting part 85 becomes operative next. After obtaining the decrypted password 30 from the password decrypting part 84, the document data decrypting part 85 makes an inquiry to the document data manager 23 about the encrypted document data D1 which is designated by the logged-in user. Based on a response from the document data manager 23, the document data decrypting part 85 reads and obtains the encrypted document data D1 which is designated as a target of the access in the storage 11. The document data decrypting part 85 then decrypts the encrypted document data D1 using the decrypted password 30. As a result, the encrypted document data D1 is converted into the accessible document data D2.

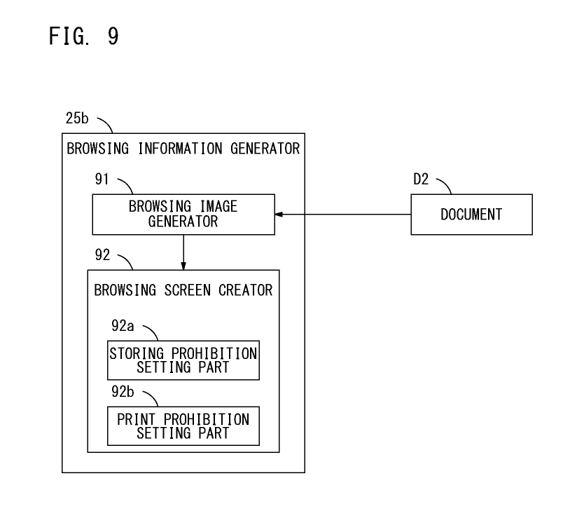

Referring back to FIG. 4, the decrypted document data D2 is generated as described above. The browsing information generator 25b is then brought into operation in the browsing information providing unit 25. The browsing information generator 25b generates a browsing image based on the decrypted document data D2, and creates a browsing screen containing the browsing image. FIG. 9 is a block diagram showing an example of a detailed functional structure of the browsing information generator 25b. As shown in FIG. 9, the browsing information generator 25b includes a browsing image generator 91 and a browsing screen creator 92. The browsing screen creator 92 includes a storing prohibition setting part 92a and a print prohibition setting part 92b.

The browsing image generator 91 generates the browsing image based on the decrypted document data D2. The browsing image is the bitmap image data, for instance. The browsing image is the image data for preview generated by making a picture of the contents such as the text contained in the document data D2 as they are. It is assumed that the logged-in user is browsing the browsing image displayed on the display area of the information processing device 4. In this case, the preview image data helps preventing in advance the copy of the contents data such as the text contained in the document data D2 as the original data.

After the preview image is generated by the browsing image generator 91 based on the document data D2, the browsing screen creator 92 creates the browsing screen containing the browsing image. The browsing screen is created as a web page described in HTTP (Hypertext Transfer Protocol), for instance. In creating the browsing screen, the browsing information transmitter 25c brings the storing prohibition setting part 92a and the print prohibition setting part 92b into operation.

The storing prohibition setting part 92a disables a storage function of the browsing screen of the web browser 48 run on the information processing device 4. The storing prohibition setting part 92a, for example, incorporates a command that disables the storage function of the web browser 48 into the browsing screen created as the web page, thereby configuring prohibition setting of storage of the browsing screen. The logged-in user may store the browsing image using the storage function of the web browser 48 as he or she is browsing the browsing screen displayed on the display area of the information processing device 4. As described above, the prohibition setting of storage of the browsing screen prevents the browsing screen to be stored outside the information sharing server 2's control.

The print prohibition setting part 92b disables a print function of the browsing screen of the web browser 48 run on the information processing device 4. The print prohibition setting part 92b, for example, incorporates a command that disables the print function of the web browser 48 into the browsing screen created as the web page, thereby configuring prohibition setting of printing of the browsing screen. The logged-in user may print the browsing image using the print function of the web browser 48 as he or she is browsing the browsing screen displayed on the display area of the information processing device 4. As described above, the prohibition setting of print of the browsing screen prevents the browsing screen to be printed outside the information sharing server 2's control.

Referring back to FIG. 4, the browsing screen is created as described above. The browsing information transmitter 25c of the browsing information providing unit 25 becomes operative next. The browsing information transmitter 25c sends the browsing screen containing the browsing image generated by the browsing information generator 25b to the logged-in user's information processing device 4 who has sent the browsing request. As a result, the logged-in user's information processing device 4 is allowed to display the browsing screen obtained from the information sharing server 2 on the display unit 42 using the function in the web browser 48.

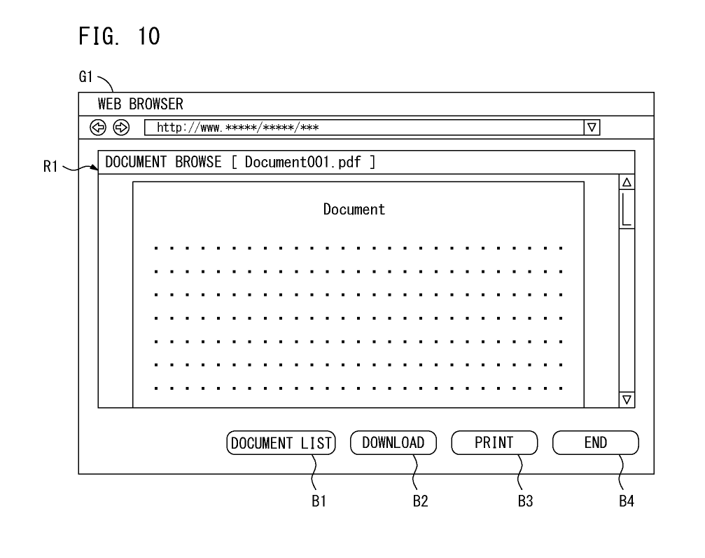

FIG. 10 shows an example of a browsing screen G1 displayed on the display area of the information processing device 4. The browsing screen G1 is displayed by the web browser 48 run on the information processing device 4. The browsing screen G1 includes a display area R1 in the center of the screen, for instance. The browsing image based on the decrypted document data D2 is displayed in the display area R1 as illustrated in FIG. 10. The aforementioned storage prohibition setting and print prohibition setting are configured for the use with the browsing screen G1. The logged-in user, therefore, is not allowed to store or print the browsing screen G1 using the function in the web browser 48.

The browsing screen G1 includes a document list button B1, a download botton B2, a print button B3 and an end button B4 in its lower part as illustrated in FIG. 10. The document list button B1 is pressed when the logged-in user requests for a list of the accessible documents to the information sharing server 2. The download botton B2 is pressed when the logged-in user requests for a download of the currently browsing document data D1 to the information sharing server 2. The print button B3 is pressed when the logged-in user requests for the print of the currently browsing document data D1 to the information sharing server 2. The end button B4 is pressed when the logged-in user wants to notify of the completion of browsing of the document data D1 to the information sharing server 2.

When the logged-in user wants to have the currently browsing document data D1, he or she presses the download botton B2. The web browser 48 then sends a download request to the information sharing server 2. When the logged-in user wants to print the currently browsing document data D1, he or she presses the print botton B3. The web browser 48 then sends a print request to the information sharing server 2.

Referring back to FIG. 4, the document data providing unit 26 becomes operative when the information sharing server 2 receives the download request from the information processing device 4. The document data providing unit 26 provides the information processing device 4 which is the sender of the download request with the document data D1 designated by the logged-in user. The document data providing unit 26 includes a data transmitter 26a and a notifier 26b.

The data transmitter 26a obtains the encrypted document data D1 which is designated to download in the storage 11. Also, the data transmitter 26a obtains the password 30 to decrypt the encrypted document data D1 from the browsing information providing unit 25. The data transmitter 26a may read the encrypting password 31 in the storage 11, and decrypt the encrypting password 31 using the decryption key 14e, thereby obtaining the password 30. The data transmitter 26a then sends the encrypted document data D1 and the password 30 to the logged-in user's information processing device 4 which is the sender of the download request. As a result, the logged-in user is allowed to download the encrypted document data D1 and the password 30. The logged-in user decrypts the encrypted document data D1 using the password 30, thereby making the document data D1 available for him or her.

The data transmitter 26a may send each of the encrypted document data D1 and the password 30 over the different communication path. The data transmitter 26a, for example, may send the encrypted document data D1 to the web browser 48 of the information processing device 4 and the password 30 to the logged-in user by email, for instance. Each of the encrypted document data D1 and the password 30 is sent over the different communication path as described above, resulting in a system with much higher security.

After the encrypted document data D1 and the password 30 are sent by the data transmitter 26a, the notifier 26b notifies the user who uploaded the document data D1 (hereafter, upload user) that the document data D1 is downloaded. In notifying the upload user, the notifier 26b preferably gives information such as information as to the user who downloaded the document data D1 and a downloaded date and time. The notifier 26b may notify not only the user who uploaded the document data D1 but also every user in the same group and the administrator.

The print controller 27 becomes operative when the information sharing server 2 receives the print request from the information processing device 4. The print controller 27 sends the document data D1 designated by the logged-in user to a printer specified by the logged-in user. After receiving the print request, the print controller 27 searches for the printer installed in the same local network as the information processing device 4 which is the sender of the print request. There may be the printer installed in the same local network as the information processing device 4. In this case, the print controller 27 shows the printer to the logged-in user, and receives an operation to specify the printer by the logged-in user. The printer may not be found as a result of the search. In this case, the print controller 27 receives an operation to set the printer input by the logged-in user by manual, and identifies the printer to send the print data based on the manual operation. The print controller 27 includes a print data transmitter 27a and a notifier 27b.

The data transmitter 27a sends the print data to the printer identified as the address of the print data. The data transmitter 27a determines whether or not a printer driver corresponding to the printer identified as the address of the print data has been installed. If the printer driver is installed, the data transmitter 27a starts up the printer driver and generates the print job that enables print to the identified printer. To be more specific, in starting up the printer driver and sending the print job to the printer, the data transmitter 27a generates the print job based on the decrypted document data D2 and sends the generated print job to the printer.

The printer driver corresponding to the printer identified as the address of the print data may not be installed. In this case, the data transmitter 27a determines that the identified printer is a machine that enables the user to print directly to it. The data transmitter 27a then sends the document data D1 as it is to the printer. To be more specific, when the printer is the machine that enables the user to print directly to the machine, the data transmitter 27a sends the encrypted document data D1 and the password 30 to decrypt the document data to the printer. The document data D1 is decrypted at the printer so that the document data D2 that may be printed is generated and the printed output is produced based on the document data D2.

It is assumed, for example, the aforementioned image processing device 5 is identified as the printer. In this case, the image processing device 5 receives the encrypted document data D1 and the password 30 from the information sharing server 2. The print job executing unit 72 then becomes operative at the image processing device 5. The print job executing unit 72 decrypts the encrypted document data D1 using the password 30. As a result, the print job executing unit 72 is allowed to obtain the document data D2 that may be printed. The print job executing unit 72 then produces the printed output based on the document data D2. The information sharing server 2 is allowed to print to the image processing device 5 even without installation of the printer driver corresponding to the image processing device 5, resulting in less load on the information sharing server 2.

After the print data is sent by the print data transmitter 27a, the notifier 27b notifies the user who uploaded the document data D1 that the printed output is produced. For notifying the upload user, the notifier 27b preferably gives information such as the information as to the user who instructed the print and a print date and time. The notifier 27b may notify not only the user who uploaded the document data D1 but also every user in the same group and the administrator.

As described above, after the document data D1 is downloaded or the printed output is produced based on the document data D1 in response to the instruction by the logged-in user, the information sharing server 2 notifies the user who is at least in the same group as the logged-in user but other than the logged-in user. If the document data D1 is leaked to a third person, a leak source may be identified immediately.

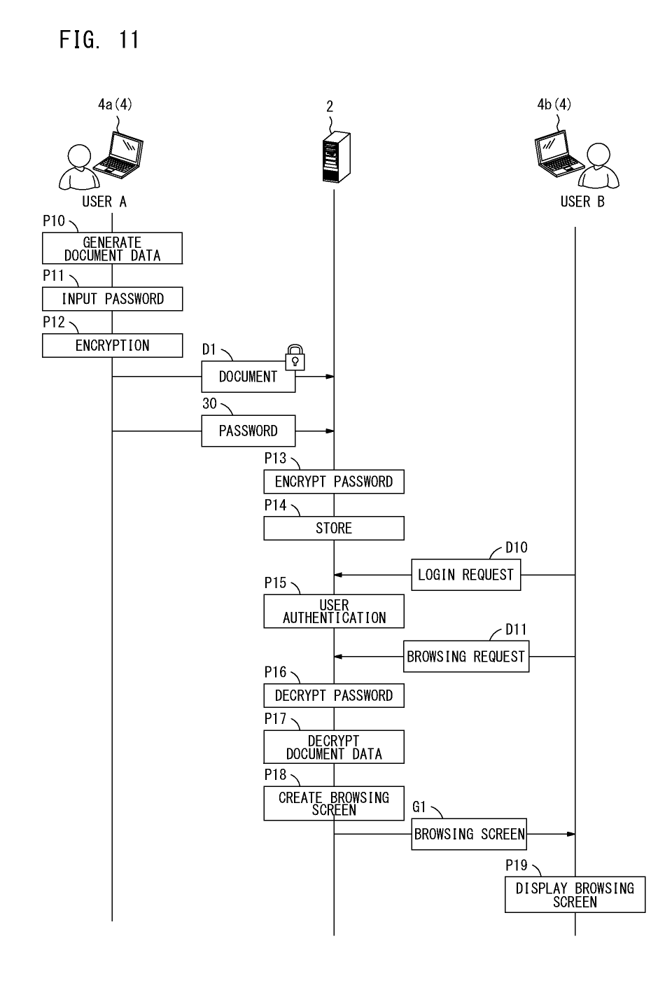

An outline of operations performed in the aforementioned information sharing system 1 is explained next. FIG. 11 is a flow diagram showing an exemplary process sequence when the user A uploads the document data D1 to the information sharing server 2 and the user B browses to the document data D1. In the example of FIG. 11, the user A uses an information processing device 4a, and the user B uses an information processing device 4b.

The user A operates the information processing device 4a to create the document data D1 to upload to the information sharing server 2 (process P10). The document data D1 may contain confidential information. In this case, the user A inputs the password 30 to the information processing device 4a (process P11), and encrypts the document data D1 with the password 30 (process P12). The user A then operates the information processing device 4a to log into the information sharing server 2 and uploads the encrypted document data D1 to the information sharing server 2. The information processing device 4a sends the password 30 to decrypt the encrypted document data D1 to the information sharing server 2.

After receiving the encrypted document data D1 and the password 30 from the information processing device 4a, the information sharing server 2 refers to the sharing information 14 to identify the user A's group. The information sharing server 2 obtains the encryption key 14d set for the user A's group. The information sharing server 2 encrypts the password 30 received from the information processing device 4a with the encryption key 14d, and creates the encrypting password 31 (process P13). The information sharing server 2 associates the encrypted document data D1 and the encrypting password 31 with each other and stores them in the storage 11 (process P14). The password 30 received from the information processing device 4a is stored in the storage 11 as the encrypting password 31 which is encrypted. If the encrypted document data D1 and the encrypting password 31 are read fraudulently, the encrypted document data D1 is not allowed to be decrypted, preventing the leakage of the information. The information sharing server 2 preferably delete the original password 30 when encrypting the password 30 received from the information processing device 4a with the encryption key 14d. The information sharing server 2 discloses the document data D1 uploaded by the user A to the other users in the same group as the user A.

When the user B who is in the same group as the user A browses the document data D1, he or she operates the information processing device 4b to start up the web browser 48, and accesses the information sharing server 2. The screen to log into the information sharing server 2 then appears on the information processing device 4b. The user B inputs his or her authentication information 14c notified in advance on the screen, and sends the login request D10 to the information sharing server 2. After receiving the login request D10, the information sharing server 2 performs the user authentication (process P15). The user B may be the user who is registered with the sharing information 14. In this case, the information sharing server 2 sends the list of the document data D1 which may be browsed by the user B is allowed to access to the information processing device 4b. The user B is allowed to obtain the list of the docuent data D1 disclosed to his or her group. The user B is allowed to sent the browsing request D11 designating the document data D1 on the list to the information sharing server 2.

After receiving the browsing request D1i from the information processing device 4b, the information sharing server 2 reads the decryption key 14e registered for the user B's group, and decrypts the encrypting password 31 corresponding to the document data D1 designated as the data to browse (process P16). As a result, the encrypting password 31 is converted into the password 30 to decrypt the encrypted document data D1. The information sharing server 2 decrypts the encrypted document data D1 using the decrypted password 30 (process P17). The encrypted document data D1 is ecrypted to the accessible document data D2. The information sharing server 2 then creates the browsing screen G1 containing the browsing image based on the decrypted document data D2 (process P18), and sends the created browsing screen G1 to the information processing device 4b. After receiving the browsing screen G1 from the information sharing server 2, the information processing device 4b displays the browsing screen G1 on the display unit 42. The user B is allowed to browse the detail of the document data D1. Hence, the user B is allowed to browse the detail of the document data D1 even though he or she does not know the password protecting the document data D1 set by the user A.

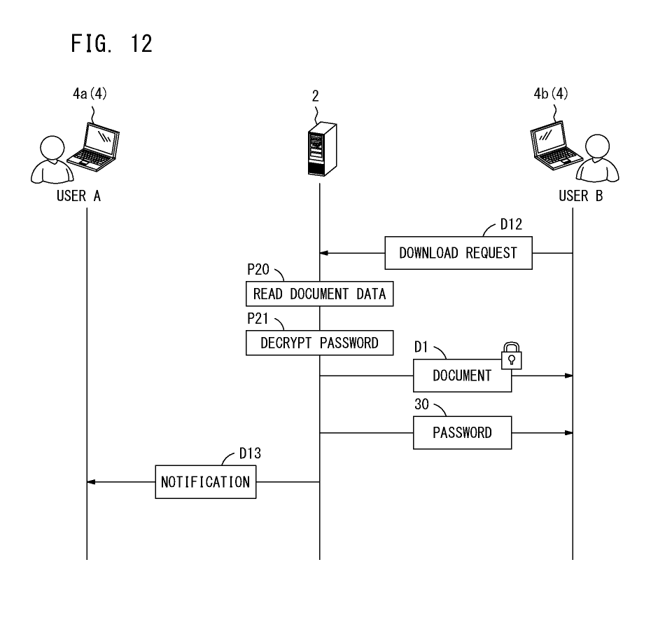

FIG. 12 is a flow diagram showing an exemplary process sequence when the user B downloads the document data D1. It is assumed that the user B presses the download button B2 as he or she is browsing the document data D1. The information processing device 4b then sends a download request D12 to request for the download of the browsing document data D1 to the information sharing server 2. After receiving the download request D12 from the information processing device 4b, the information sharing server 2 reads the encrypted document data D1 identified as the data to be downloaded in the storage 11 (process P20). The information sharing server 2 reads the encrypting password 31 associated with the document data D1 which is to be downloaded, and decrypts the encrypting password 31 using the decryption key 14e (process P21). The encrypting password 31 is converted into the password 30 to decrypt the encrypted document data D1. The information sharing server 2 sends the enctypted document data D1 and the decrypted password 30 to the information processing device 4b. As a result, the user is allowed to decrypt the encrypted document data D1 using the password 30 at the information processing device 4b. The information sharing server 2 then sends a notification D13 to the user A who is the upload user of the document data D1 to notify that the document data D1 is downloaded by the user B. The user A is allowed to know that the confidential document created by him or her has been accessed by the user B on a real-time basis.

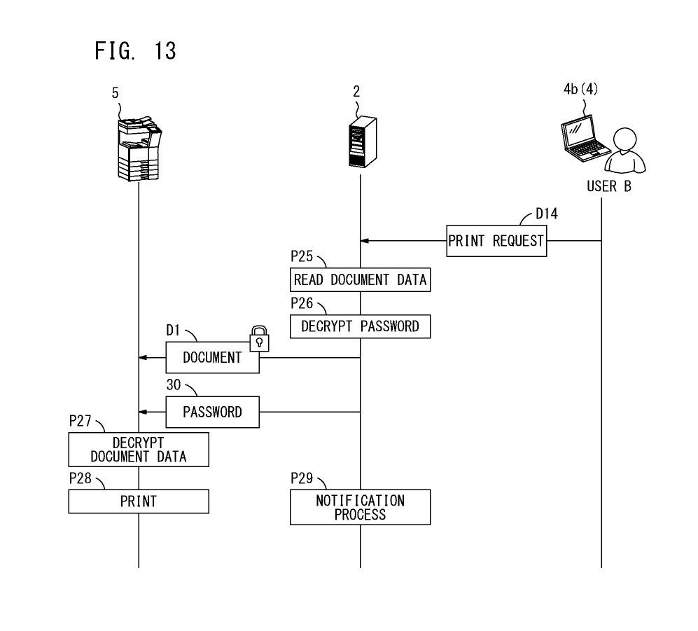

FIG. 13 is a flow diagram showing an exemplary process sequence when the user B prints the document data D1. In the example of FIG. 13, the user B designates the image processing device 5 as a printer. It is assumed that the user B presses the print button B3 as he or she is browsing the document data D1. The information processing device 4b then sends a print request D14 to request for the print of the browsing document data D1 to the information sharing server 2. After receiving the print request D14 from the information processing device 4b, the information sharing server 2 detects that the image processing device 5 is designated as the printer. The printer driver that corresponds to the image processing device 5 may not be installed. In this case, the information sharing server 2 determines to send the encrypted document data D1 and the password 30 to the image processing device 5. The information sharing server 2 then reads the encrypted document data D1 identified as the data to print in the storage 11 (process P25). The information sharing server 2 reads the encrypting password 31 associated with the document data D1 which is to be printed, and decrypts the encrypting password 31 using the decryption key 14e (process P26). The encrypting password 31 is converted into the password 30 to decrypt the encrypted document data D1. The information sharing server 2 sends the enctypted document data D1 and the decrypted password 30 to the image processing device 5.

After receiving the encrypted document data D1 and the password 30 from the information sharing server 2, the image processing device 5 decrypts the encrypted document data D1 using the password 30 (process P27). The encrypted document data D1 is converted into the printable document data D1. The image processing device 5 produces the printed output based on the decrypted document data D2 (process P28). When sending the encrypted document data D1 and the password 30 to the image processing device 5, the information sharing server 2 performs a notification process to send the notification to the user A who is the upload user of the document data D1 (process P29). The user A is allowed to find out that the confidential document created by him or her has been printed by the user B on the real-time basis.

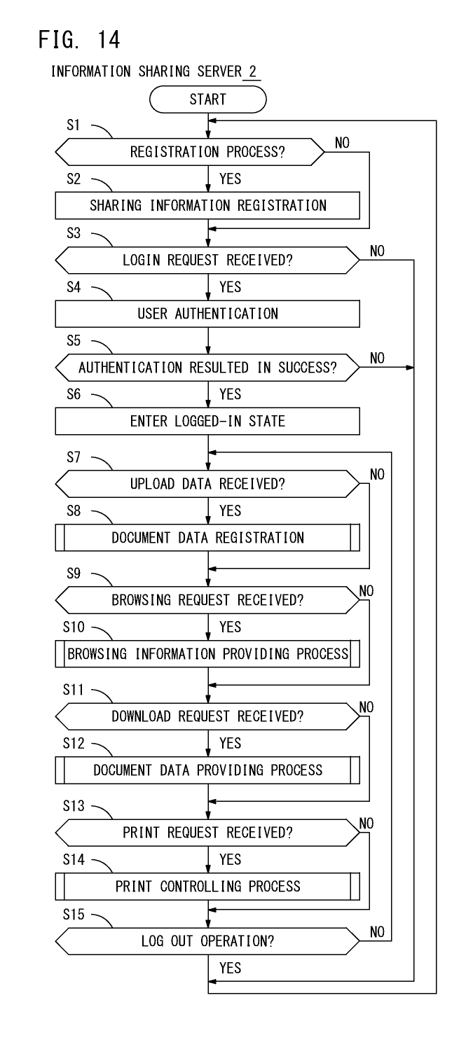

The detailed procedure of a process performed by the information sharing server 2 is explained next. FIGS. 14 to 18 are flow diagrams explaining an exemplary procedure of the process performed by the information sharing server 2. The process is preformed when the CPU of the controller 10 of the information sharing server 2 reads and executes the program 13.

Upon the start of the process, the information sharing server 2 determines whether or not to perform the registration process as shown in FIG. 14 (step S1). The information sharing server 2 determines, for example, if the registration of the new group or the new user has been instructed by the administrator. For performing the registration process (when a result of step S1 is YES), the information sharing server 2 performs a sharing information registration (step S2). In the sharing information registration (step S2), the new information is registered with the sharing information 14 based on the operation to register the new group or the new user by the administrator. When the registration process is not performed (when a result of step S1 is NO), the process in step S2 is skipped.

The information sharing server 2 determines if the login request D10 from the information processing device 4 is received (step S3). The login request D10 may be received (when a result of step S3 is YES). In this case, the information sharing server 2 performs the user authentication (step S4) to determine if the authentication results in success (step S5). When the authentication results in success (when a result of step S5 is YES), the information sharing server 2 enters the logged-in state in which the user who sent the login request D10 is logged in as the logged-in user (step S6). The logged-in user is then allowed to browse the document data D1 shared in his or her group. After entering the logged-in state, the information sharing server 2 determines whether or not the upload data is received from the logged-in user (step S7). When the upload data is received (when a result of step S7 is YES), the information sharing server 2 performs a document data registrateion (step S8). The detail of the document data registration is explained later. The information sharing server 2 then determines if the browsing request D11 is received from the logged-in user (step S9). The browsing request D11 may be received (when a result of steo S9 is YES). In this case, the information sharing server 2 performs a browsing information providing process (step S10). The detail of the browsing information providing process is explained later. The information sharing server 2 determines if the download request D12 is received from the logged-in user (step S11). The download request D12 may be received (when a result of steo S11 is YES). In this case, the information sharing server 2 performs a document data providing process (step S12). The detail of the document data providing process is explained later. The information sharing server 2 determines if the print request D14 is received from the logged-in user (step S13). The print request D14 may be received (when a result of steo S13 is YES). In this case, the information sharing server 2 performs a print controlling process (step S14). The detail of the print controlling process is explained later. As the user is logging into the information sharing server 2 (when a result of step S2 is NO), the process in the aforementioned steps S7 to S14 is performed repeatedly. When the user is not logged in (when a result of step S3 is NO or step S5 is NO), the process in the steps S7 to S14 is not performed and skipped. The information sharing server 2 performs the process in the aforementioned steps S1 to S15 repeatedly.

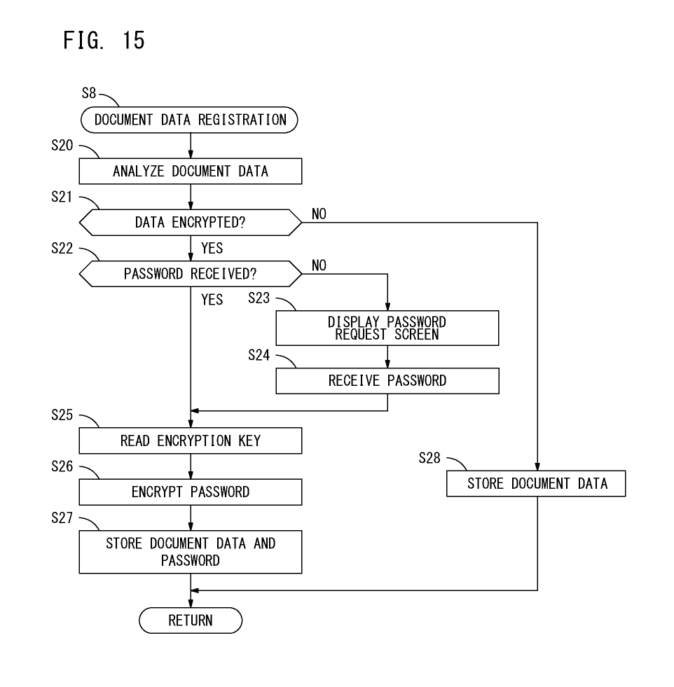

FIG. 15 is a flow diagram explaining in detail an exemplary procedure of the document data registrateion (step S8). Upon the start of the process, the information sharing server 2 analyzes the document data D1 obtained as the upload data (step S20), and determines whether or not the document data D1 is encrypted (step S21). The document data D1 may be encrypted (when a result of step S21 is YES). In this case, the information sharing server 2 determines if the password 30 is received together with the encrypted document data D1 (step S22). When it is determined the password 30 is not received (when a result of step S22 is NO), the information sharing server 2 enables the information processing device 4 that uploaded to display the password request screen (step S23). The upload user is allowed to input the password to decrypt the encrypted document data D1. The password 30 is sent to the information sharing server 2. The information sharing server 2 then receives the password 30 from the information processing device 4 (step S24). If the password 30 is contained in the received upload data (when a result of step S22 is YES), the process in steps in S23 and S24 is unnecessary.

The information sharing server 2 identifies the upload user's group, and reads the encryption key 14d registered for the identified group (step S25). The information sharing server 2 encrypts the password 30 received from the information processing device 4 with the encryption key 14d (step S26). The information sharing server 2 then may discard the password 30 received from the information processing device 4. The information sharing server 2 associates the encrypted document data D1 and the encrypting password 31 with each other and stores them in the storage 11 (step S27).

The document data D1 contained in the upload data may not be encrypted (when a result of step S21 is NO). In this case, the information sharing server 2 determines that the document data D1 is the low confidential information, and stores and manages the received document data D1 as it is in the storage 11 (step S28).

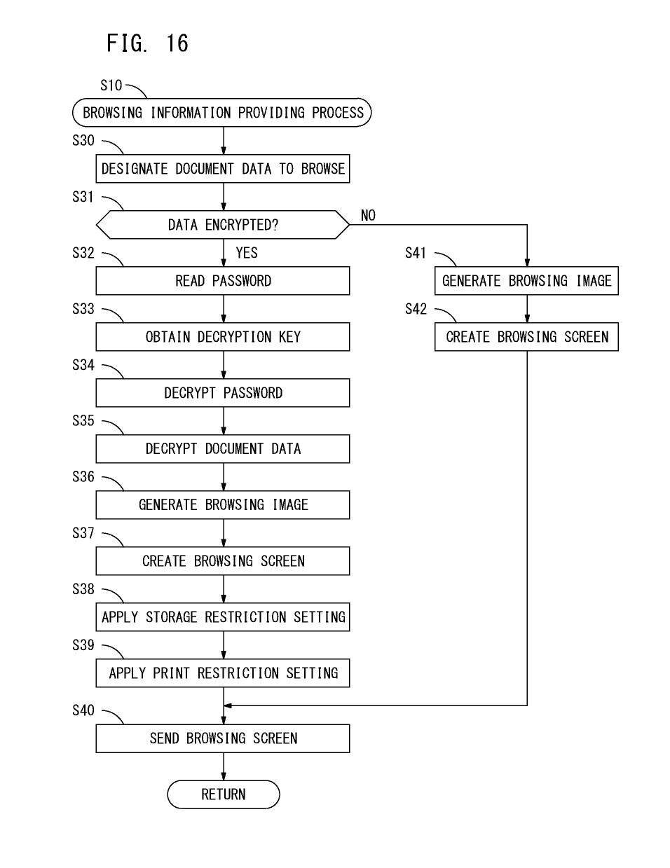

FIG. 16 is a flow diagram explaining in detail an exemplary procedure of the browsing information providing process (step S10). Upon the start of the process, the information sharing server 2 designates the document data D1 to browse (step S30). The information sharing server 2 determines if the document data D1 is encrypted (step S31). When the data to browse is the encrypted document data D1 (when a result of step S31 is YES), the information sharing server 2 reads the encrypting password 31 associated with the encrypted document data D1 (step S32). The information sharing server 2 then obtains the decryption key 14e to decrypt the encrypting password 31 (step S33), and decrypts the encrypting password 31 (step S34). As a result, the encrypting password 31 is converted into the password 30 which is used to decrypt the encrypted document data D1. The information sharing server 2 decrypts the encrypted document data D1 with the decrypted password 30 (step S35).

The information sharing server 2 then generates the browsing image based on the decrypted document data D2 (step S36), and creates the browsing screen G1 containing the browsing image (step S37). The information sharing server 2 applies the storage restriction setting with the browsing screen G1 (step S38) and the print restriction setting with the browsing screen G1 (step S39). This prevents the browsing screen G1 from being stored or printed with the function of the web browser 48 of the information processing device 4.

When the document data D1 to browse is not enctypted (when a result of step S31 is NO), the information sharing server 2 generates the browsing image based on the document data D1 (step S41), and creates the browsing screen G1 containing the browsing image (step S42). If the document data D1 is not encrypted, it is determined that the document data D1 does not contain the confidential information. Hence, the information sharing server 2 is not required to restrict the storage function or the storage function of the browsing screen G1 with the function of the web browser 48 of the information processing device 4. When the document data D1 is not encrypted, the information sharing server 2 does not apply the storage restriction setting or the print restriction setting with the browsing screen G1.

The information sharing server 2 sends the browsing screen G1 created as described above to the information processing device 4 which is the sender of the browsing request D11 (step S40). The logged-in user is allowed to browse the detail of the document data D1 on his or her information processing device 4.

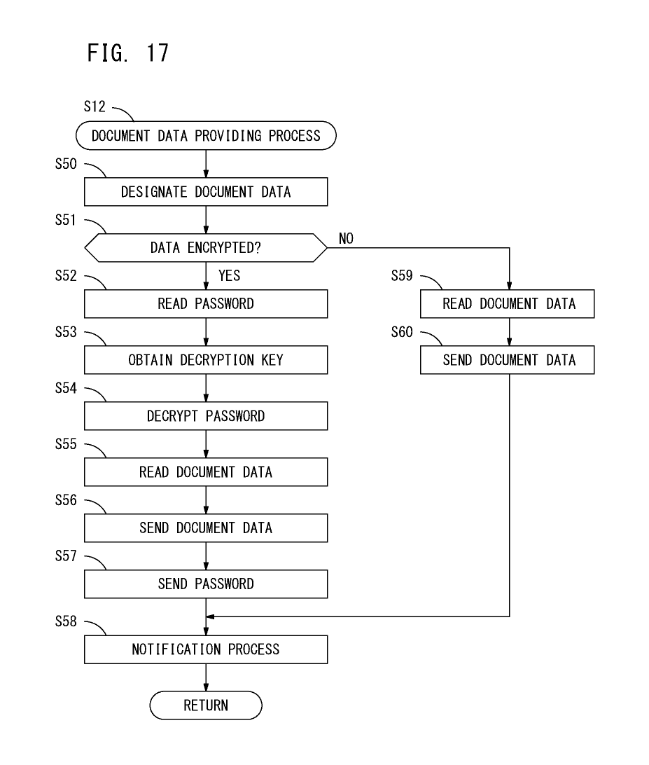

FIG. 17 is a flow diagram explaining in detail an exemplary procedure of the document data providing process (step S12). Upon the start of the process, the information sharing server 2 designates the document data D1 to download (step S50). The information sharing server 2 determines if the document data D1 is encrypted (step S51). When the data to download is the encrypted document data D1 (when a result of step S51 is YES), the information sharing server 2 reads the encrypting password 31 associated with the encrypted document data D1 (step S52). The information sharing server 2 obtains the decryption key 14e to decrypt the encrypting password 31 (step S53), and decrypts the encrypting password 31 (step S54). As a result, the encrypting password 31 is converted into the password 30 which is used to decrypt the encrypted document data D1. The information sharing server 2 reads the encrypted document data D1 to download (step S55) and sends the encrypted document data D1 to the information processing device 4 which is the sender of the download request D12 (step S56). The information sharing server 2 sends the decrypted password 30 to the information processing device 4 (step S57). The information sharing server 2 then performs the notification process to notify the upload user that the document data D1 is downloaded (step S58).

When the document data D1 to download is not enctypted (when a result of step S51 is NO), the information sharing server 2 reads the document data D1 to download (step S59), and sends the document data D1 as it is to the information processing device 4 (step S60). The information sharing server 2 then performs the notification process to notify the upload user that the document data D1 is downloaded (step S58).

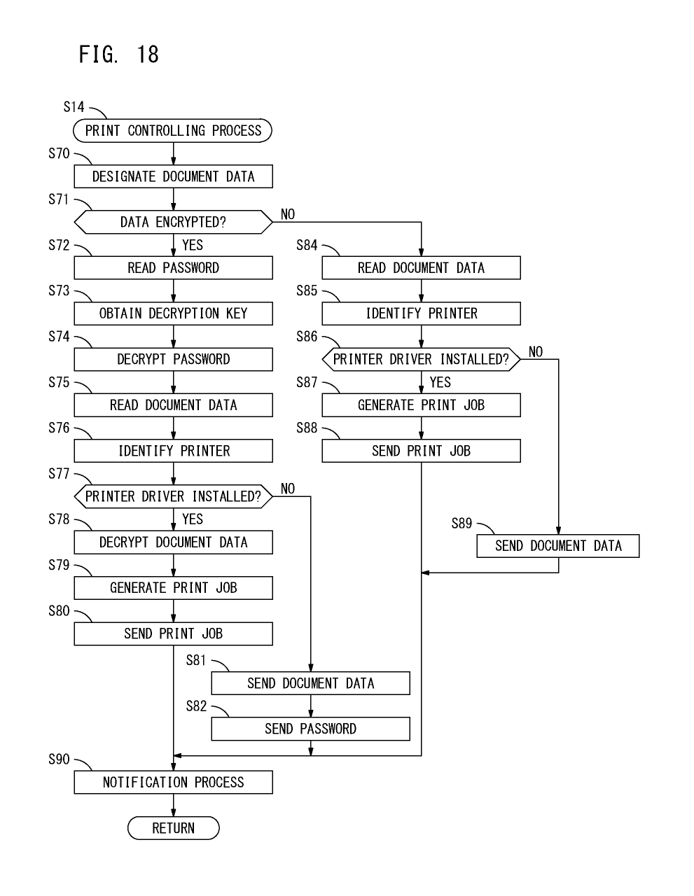

FIG. 18 is a flow diagram explaining in detail an exemplary procedure of the print controlling process (step S14). Upon the start of the process, the information sharing server 2 designates the document data D1 to print (step S70). The information sharing server 2 determines if the document data D1 is encrypted (step S71). When the data to print is the encrypted document data D1 (when a result of step S71 is YES), the information sharing server 2 reads the encrypting password 31 associated with the encrypted document data D1 (step S72). The information sharing server 2 obtains the decryption key 14e to decrypt the encrypting password 31 (step S73), and decrypts the encrypting password 31 (step S74). As a result, the encrypting password 31 is converted into the password 30 which is used to decrypt the encrypted document data D1. The information sharing server 2 reads the encrypted document data D1 to print (step S75).

The information sharing server 2 identifies the printer (step S76), and determines if the printer driver corresponding to the identified printer is installed (step S77). The printer driver corresponding to the identified printer may be installed (when a result of step S77 is YES). In this case, the information sharing server 2 decrypts the enctypted document data D1 with the decrypted password 30 (step S78). The information sharing server 2 generates the print job that may be executed at the printer based on the document data D2 generated by decrypting the document data D1 (step S79), and sends the print job to the printer (step S80).

The printer driver corresponding to the identified printer may not be installed (when a result of step S77 is NO). In this case, the information sharing server 2 sends the encrypted document data D1 to the printer (step S81). Also, the information sharing server 2 sends the decrypted password 30 to the printer (step S82). As a result, the printer is allowed to produce the printed output by decrypting the encrypted document data D1.

When the document data D1 to print is not enctypted (when a result of step S71 is NO), the information sharing server 2 reads the document data D1 to print (step S84). The information sharing server 2 designates the printer (step S85), and determines if the printer driver corresponding to the designated printer is installed (step S86). The printer driver corresponding to the identified printer may be installed (when a result of step S86 is YES). In this case, the information sharing server 2 generates the print job executable at the printer based on the document data D1 (step S87). The information sharing server 2 sends the print job to the printer (step S88). The printer driver corresponding to the identified printer may not be installed (when a result of step S86 is NO). In this case, the information sharing server 2 sends the document data D1 as it is to the printer (step S89). The printer is allowed to produce the printed output based on the document data D1.

The information sharing server 2 then performs the notification process to notify the upload user that the document data D1 is printed (step S90). The upload user, therefore, is allowed to find out which user printed the document data D1 uploaded by him or her.

As described above, the information sharing server 2 in the information sharing system 1 of the first preferred embodiment is allowed to obtain the password 30 which is used to decrypt the document data D1 encrypted at the information processing device 4 after obtaining the encrypted document data D1. The information sharing server 2 associates the encrypted document data D1 and the password 30 with each other and stores. The request such as the browsing request D11 for the encrypted document data D1 may be received from another user who is authorized to browse the encrypted document data D1. In this case, the information sharing server 2 decrypts the encrypted document data D1 with the password 30 managed in association with the encrypted document data D1, and provides with the browsing information based on the document data D1 in a manner that another user is allowed to browse. Even if another user does not know the password protecting the encrypted document data D1, he or she is allowed to browse the detail of the document data D1. The user-frindliness in sharing and using the data especially the confidential document may be improved.

In providing the user who is authorized to browse with the browsing information relating to the encrypted document data D1, the information sharing server 2 of the first preferred embodiment does not provide with the decrypted document data D2 as it is. The information sharing server 2 is configured to generate the browsing image based on the decrypted document data D2 and provide with the browsing screen containing the generated browsing image. The original of contents data such as texts contained in the decrypted document data D2 may be prevented from being copied. As described above, the browsing information is provided in a way the leakage of which cannot be occurred easily.

According to the first preferred embodiment, the password 30 used to decrypt the encrypted document data D1 is not managed as it is at the information sharing server 2. The password 30 is encrypted with the encryption key 14d set for each group, and it is converted into the encrypting password 31 to be managed. It is assumed, for example, the encrypted document data D1 and the encrypting password 31 asssociated with the encrypted document data D1 are leaked outside. Even in such a case, the encrypted document data D1 cannot be decrypted using the leaked encrypting password 31. As a result, the information management with the high-security is realized.

As described above, when the document data encrypted with the password is uploaded, another user is allowed to browse the document data even if he or she does not know the password, resulting in the enhanced operability in the use of the encrypted document data.

### Second Preferred Embodiment

The second preferred embodiment of the present invention is explained next. According to the first preferred embodiment as descrived above, the password 30 to decrypt the encrypted document data D1 is encrypted at the information sharing server 2. On the other hand, in the second preferred embodiment, the password 30 to decrypt the encrypted document data D1 is encrypted at the information processing device 4 or the image processing device 5 when the encrypted document data D1 is uploaded to the information sharing server 2 from the information processing device 4 or the image processing device 5.

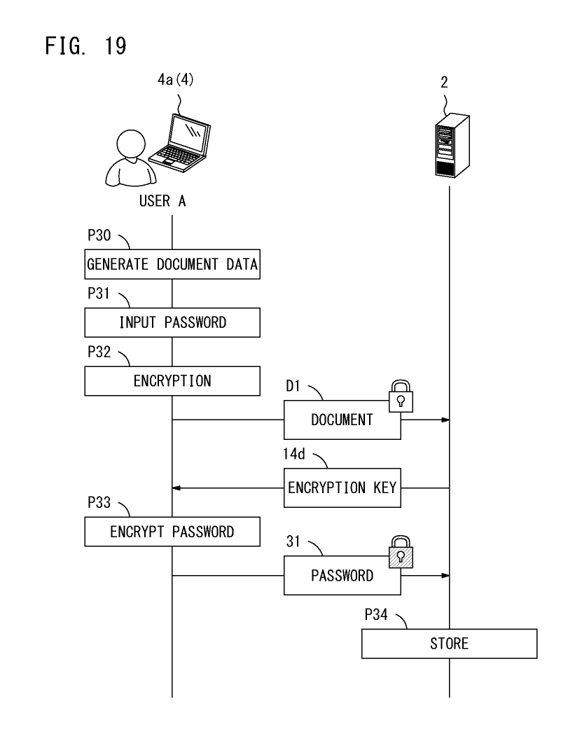

FIG. 19 is a flow diagram showing an exemplary process sequence when the user A uses the information processing device 4a to upload the document data D1 to the information sharing server 2 in the second preferred embodiment. The user A operates the information processing device 4a to create the document data D1 to upload to the information sharing server 2 (process P30). The document data D1 may contain the confidential information. In this case, the user A inputs the password 30 to the information processing device 4a (process P31), and encrypts the document data D1 with the password 30 (process P32). The user A then operates the information processing device 4a to log into the information sharing server 2 and uploads the encrypted document data D1 to the information sharing server 2.

After receiving the encrypted document data D1 from the information processing device 4a, the information sharing server 2 determines if the document data D1 is encrypted. When the data is the encrypted document data D1, the information sharing server 2 reads the encryption key 14d set for the user A's group. The information sharing server 2 sends the encryption key 14d to the information processing device 4a. The information processing device 4a is allowed to obtain the encryption key 14d set for the user A's group from the information sharing server 2.

After obtaining the encryption key 14d from the information sharing server 2, the information processing device 4a encrypts the password 30 protecting the document data D1 set by the user A (process P33). More specifically, the uploading part 56 of the web browser 48 of FIG. 2 encrypts the password 30 input by the user A with the encryption key 14d received from the information sharing server 2. As a result, the password 30 input by the user A is converted into the encrypting password 31 at the information processing device 4a in transmission of which to the information sharing server 2 from the information processing device 4a. The information processing device 4a sends the encrypting password 31 to the information sharing server 2. The information sharing server 2 is allowed to receive the encrypting password 31 encrypted at the information processing device 4a. The information sharing server 2 then associates the encrypted document data D1 received from the information processing device 4a and the encrypting password 31 with each other and stores them (process P34).

As described above, the password 30 is encrypted and the encrypting password 31 is created at the information processing device 4a so that it is not necessary to encrypt the password 30 at the information sharing server 2, resulting in less process load on the information sharing server 2.

The similar process may be applied to a case when the encrypted document data D1 is directly uploaded to the information sharing server 2 by the image processing device 5. To be more specific, the uploading part 79 of the scan application 71 of FIG. 3 encrypts the password 30 input by the user A with the encryption key 14d received from the information sharing server 2. As a result, the password 30 input by the user A is converted into the encrypting password 31 at the image processing device 5 in transmission of which to the information sharing server 2 from the image processing device 5. The information sharing server 2 sends the the encryption key 14d to the image processing device 5 when the encrypted document data D1 is received from the image processing device 5. The image processing device 5 is then allowed to receive the encrypting password 31 encrypted at the image processing device 5. Also in this case, it is not necessary to encrypt the password 30 at the information sharing server 2, resulting in less process load on the information sharing server 2.

The encryption key 14d that encrypts the password 30 is leaked to outside such as the information processing device 4a accoding to the second preferred embodiment. The decryption key 14e to decrypt the encrypting password 31, however, is not leaked to the outside, so this does not cause the low security.

Everything else in the second preferred embodiment is the same as that explained in the first preferred embodiment.

### Third Preferred Embodiment

The third preferred embodiment of the present invention is explained next. It is assumed when the user A who uploads the encrypted document data D1 to the information sharing server 2 belongs to the multiple groups, the user A would like to share the same document data D1 among the multiple groups. In such a case, the user A is required to do the same to the rest of the groups after uploading the encrypted document data D1 to one of the groups, resulting in complicated operations. The document data D1 may be required to be managed as different document data at the information sharing server 2 if the group to which the data is uploaded differs even though it is the same data. In such a case, the overlapped document data D1 places a burden on the storage area of the storage 11. In the third preferred embodimt, the operability in upload of the document data D1 shared among the multiple groups by the user A who uploads the encrypted document data D1 is enhanced and it prevents that the overlapped document data D1 places a burden on the storage area of the storage 11.

In the third preferred embodiment, when the user A, for example, uploads the encrypted document data D1 to the information sharing server 2, he or she designates the group in which the document data D1 is shared to the information sharing server 2. The user A is also allowed to designate the multiple groups he or she belongs. The user A operates his or her information processing device 4a to upload the document data D1 encrypted with the password 30 to the information sharing server 2. The information processing device 4a sends the password 30 to decrypt the encrypted document data D1 together with the encrypted document data D1 to the information sharing server 2.

After receiving the upload data from the user A's information processing device 4a, the upload data obtaining unit 22 of the information sharing server 2 of FIG. 4 extracts the encrypted document data D1 in the upload data, and outputs the extracted document data D1 to the document data manager 23. The document data manager 23 stores the encrypted document data D1 in the storage 11 and manages.

When the user A designates the multiple groups to share the encrypted document data D1 among them, the upload data obtaining unit 22 obtains the encryption kay 14d registered with each of the multiple groups designated by the user A. The upload data obtaining unit 22 encrypts the password 30 received from the user A's information processing device 4a with the encryption key 14d registered with each of the multiple groups one by one. The upload data obtaining unit 22 creates multiple encrypting passwords 31 corresponding to the respective multiple groups. The upload data obtaining unit 22 outputs the encrypting password 31 created for each group to the password manager 24. The password manager 24 stores the multiple encrypting passwords 31 in the storage 11. The password manager 24 associates the multiple encrypting passwords 31 with the single encrypted document data D1 managed by the document data manager 23 and manages.

It is assumed, for example, the user A belongs to two groups, groups X and Z and those two groups X and Z are designated as the sharing groups between which the document data D1 is shared. In this case, the upload data obtaining unit 22 encrypts the password 30 with the encryption key 14d registered with the group X, thereby creating the first encrypting password 31. The upload data obtaining unit 22 also encrypts the password 30 with the encryption key 14d registered with the group Z, thereby creating the second encrypting password 31. These created encrypting passwords 31 are associated with the single encrypted document data D1 and managed. Another user who belongs to the group X may send the browsing request D11 for the document data D1. In this case, the browsing information providing unit 25 decrypts the first encrypting password 31, thereby obtaining the password 30 to decrypt the encrypted document data D1. Another user who belongs to the group Z may send the browsing request D11 for the document data D1. In this case, the browsing information providing unit 25 decrypts the second encrypting password 31, thereby obtaining the password 30 to decrypt the encrypted document data D1.

Hense, according to the third preferred embodiment, the user A is only required to designate that the document data D1 to upload is shared among the multiple groups when he or she uploads the document data D1. He or she is not necessary to repeatedly upload the same document data, resulting in greate operability. In the third preferred embodiment, the single encrypted document data D1 is shared among the multiple groups. The overlapped document data D1 does not place a burden on the storage area of the storage 11.

As described above, the upload data obtaining unit 22 of the information sharing server 2 encrypts the password 30 received from the information processing device 4 for each group with the corresponding encryption key 14d. However, this is given not for limitation. As described in the second preferred embodiment, the upload data obtaining unit 22 may send the encryption key 14d registered with the respective groups to the information processing device 4a to obtain the multiple encrypting passwords 31 enctypted at the information processing device 4a. Everything else in the third preferred embodiment is the same as that explained in the first and the second preferred embodiments.

### (Modifications)

While the preferred embodiments of the present invention have been described above, the present invention is not limited to the preferred embodiments. Various modifications may be applied to the present invention.

In the above-described preferred embodiments, for example, the information sharing server 2 is installed on the cloud connected to the internet. However, this is given not for limitation. To be more specific, the information sharing server 2 may be installed on the local network.

As described above in the first, second and third preferred embodiments, the encryption key 14d to encrypt the password 30 and the decryption key 14e to decrypt are the separate key information in a pair. According to the above-described first preferred embodiment, it is not necessary for the encryption key 14d and the decryption key 14e to be the separate key information. Those keys may be the same key information such as the password, for instance.

Although the embodiment of the present invention has been described and illustrated in detail, it is clearly understood that the same is by way of illustration and example only and not limitation, the scope of the present invention should be interpreted by terms of the appended claims.

What is claimed is:

1. An information sharing server, comprising a hardware processor that:
registers multiple users who share document data as members of a group;
obtains the document data encrypted by one user of the multiple users in said group and a password to decrypt the encrypted document data;
stores the encrypted document data and said password in association with each other on a predetermined storage;
reads the encrypted document data and said password in said storage and decrypts the encrypted document data using said password when a request for browsing of the encrypted document data is received from one of the multiple users in said group; and
provides a sender of said request for browsing with the decrypted document data.

2. The information sharing server according to claim 1, wherein
said hardware processor generates a browsing image based on the decrypted document data, and sends said browsing image to the sender of said request for browsing.

3. The information sharing server according to claim 1, wherein
said hardware processor registers a pair of an encryption key and a decryption key as information corresponding to said group,
an encrypting password generated by encryption of said password with said encryption key is stored in said storage, and
said hardware processor decrypts said password from said encrypting password using said decryption key to decrypt the encrypted document data.

4. The information sharing server according to claim 3, wherein
said hardware processor encrypts said password using said encryption key and generages said encrypting password when said password is obtained.

5. The information sharing server according to claim 3, wherein
said hardware processor sends said encryption key to a sender of the encrypted document data, thereby enabling the sender of the encrypted document data to encrypt said password and obtaining said encrypting password from the sender of the encrypted document data.

6. The information sharing server according to claim 3, wherein
a first encrypting password generated by encryption of said password with said encryption key registered corresponding to said group and a second encrypting password generated by encryption of said password with the encryption key registered corresponding to another group which is different from said group are stored in said storage when said one user of the multiple users is registered as the member of said another group and said one user instructs to share the encrypted document data between said group and said another group.

7. The information sharing server according to claim 1, wherein
said hardware processor sends the encrypted document data and said password to a sender of a request for download of the encrypted document data when said request for download is received from one of the multiple users in said group.

8. The information sharing server according to claim 7, wherein
said hardware processor notifies said one user of the multiple users of information relating to the user who sent said request for download when the encrypted document data and said password are sent by said document data transmitter.

9. The information sharing server according to claim 1, wherein
said hardware processor sends the encrypted document data and said password to a printer that is designated in a request for print of the encrypted document data when said request for print is received from one of the multiple users in said group.

10. An information sharing system, comprising:
an information sharing server according to claim 1; and
an information processing device that uploads document data to said information sharing server, wherein said information processing device includes a second hardware processor that:
encrypts the document data with a password specified by a user; and
uploads the encrypted document data and said password to said information sharing server.

11. An information sharing system, comprising:
an information sharing server according to claim 1; and
an image processing device that uploads document data to said information sharing server, wherein said image processing device includes:
a document reader that generates the document data by reading a document; and
a second hardware processor, wherein said second hardware processor:
encrypts the document data generated by said document reader with a password specified by a user; and
uploads the encrypted document data and said password to said information sharing server.

12. The information sharing system according to claim 10, wherein
said second hardware processor encrypts said password with an encryption key, thereby generating an encrypting password, and uploads said encrypting password to said information sharing server when said encryption key is received from said information sharing server after the encrypted document data is uploaded to said information sharing server.

13. A non-transitory recording medium storing a computer readable program, execution of the computer readable program by a computer causing the computer to perform:
registering multiple users who share document data as members of a group;
obtaining the document data encrypted by one user of the multiple users in said group and a password to decrypt the encrypted document data;
storing the encrypted document data and said password in association with each other;
reading the encrypted document data and said password and decrypting the encrypted document data using said password when a request for browsing of the encrypted document data is received from one of the multiple users in said group; and
providing a sender of said request for browsing with the decrypted document data.

14. The non-transitory recording medium according to claim 13, wherein
a browsing image is generated based on the decrypted document data, and said browsing image is sent to the sender of said request for browsing.

15. The non-transitory recording medium according to claim 13, wherein the computer readable program causes the computer to further perform:
registering a pair of an encryption key and a decryption key as information corresponding to said group,
storing an encrypting password generated by encryption of said password with said encryption key, and
decrypting said password from said encrypting password using said decryption key when the encrypted document data is decrypted.

16. The non-transitory recording medium according to claim 15, wherein the computer readable program causes the computer to further perform:
generating said encrypting password by engcrypting said password with said encryption key, when said password is obtained.

17. The non-transitory recording medium according to claim 15, wherein
said encryption key is sent to a sender of the encrypted document data so that the sender of the encrypted document data is enabled to encrypt said password and said encrypting password is obtained from the sender of the encrypted document data.

18. The non-transitory recording medium according to claim 15, wherein
a first encrypting password generated by encryption of said password with said encryption key registered corresponding to said group and a second encrypting password generated by encryption of said password with the encryption key registered corresponding to another group which is different from said group are stored, when said one user of the multiple users is also registered as the member of said another group and said one user instructs to share the encrypted document data between said group and said another group.

19. The non-transitory recording medium according to claim 13, wherein the computer readable program causes the computer to further perform:
sending the encrypted document data and said password to a sender of a request for download of the encrypted document data when said request for download is received from one of the multiple users in said group.

20. The non-transitory recording medium according to claim 19, wherein the computer readable program causes the computer to further perform:
notifying said one user of the multiple users of information relating to the user who sent said request for download when the encrypted document data and said password are sent to the user.

21. The non-transitory recording medium according to claim 13, wherein the computer readable program causes the computer to further perform:
sending the encrypted document data and said password to a printer that is designated in a request for print of the encrypted document data when said request for print is received from one of the multiple users in said group.
